(19) United States
(12) Patent Application Publication
(10) Pub. No.: US 2024/0196266 A1
(43) Pub. Date: Jun. 13, 2024

(54) TIME-SENSITIVE DATA OVER WI-FI

(71) Applicant: MaxLinear, Inc., Carlsbad, CA (US)

(72) Inventor: Sigurd Schelstraete, Menlo Park, CA (US)

(73) Assignee: MaxLinear, Inc., Carlsbad, CA (US)

(21) Appl. No.: 18/539,192

(22) Filed: Dec. 13, 2023

Related U.S. Application Data
(60) Provisional application No. 63/387,281, filed on Dec. 13, 2022.

(51) Int. Cl. H04W 28/02; H04L 1/00

(52) U.S. Cl. CPC H04W 28/0268; H04L 1/0008; H04W 84/12

(57) ABSTRACT

A number of methods for reducing latency of time-sensitive data transmissions are described. A first one of the methods describes reducing the latency of data transmissions containing time-sensitive data arriving at a predictable time. A second one of the method describes reducing the latency of data transmissions containing time-sensitive data arriving at an unpredictable time. Both methods involve adding padding to the data transmissions to help align data fields of the data transmission with an arrival time of the time-sensitive data.

### CROSS-REFERENCE TO RELATED APPLICATIONS

This application claims priority to U.S. Provisional Patent Application No. 63/387,281 filed on Dec. 13, 2022 and entitled “TIME-SENSITIVE DATA OVER WI-FI”, which is incorporated by reference in its entirety.

### TECHNICAL FIELD

This disclosure relates to wireless communication, and more specifically, time-sensitive data over Wi-Fi.

### BACKGROUND

Institute of Electrical and Electronics Engineers (IEEE) 802.11 standards include protocols for implementing wireless local area network (WLAN) communications, including Wi-Fi.

The subject matter claimed in the present disclosure is not limited to implementations that solve any disadvantages or that operate only in environments such as those described above. Rather, this background is only provided to illustrate one example technology area where some embodiments described in the present disclosure may be practiced.

### SUMMARY

This paper describes various embodiments that relate to methods for reducing latency of time-sensitive data transmissions.

A system for wireless communication is described. The system includes data processing hardware; and memory hardware in communication with the data processing hardware, the memory hardware storing instructions that when executed on the data processing hardware cause the data processing hardware to perform operations including: (1) predicting an arrival time for time-sensitive data; initiating a data transmission prior to the predicted arrival time for the time-sensitive data; and when an actual arrival time of the time-sensitive data and a beginning of a data field of the data transmission are not aligned, adding padding to the data transmission to align the beginning of the data field with the actual arrival time.

Padding is generally added to the beginning of the data field until the time-sensitive data becomes available following the actual arrival time of the time-sensitive data.

A method for reducing latency of a data transmission is described and includes: (1) predicting an arrival time for time-sensitive data; initiating a data transmission prior to the predicted arrival time for the time-sensitive data; and when an actual arrival time of the time-sensitive data and a start of a data field of the data transmission are not aligned, adding padding to the data transmission to align the start of the data field with the actual arrival time.

A system for wireless communication is described and includes data processing hardware; and memory hardware in communication with the data processing hardware, the memory hardware storing instructions that when executed on the data processing hardware cause the data processing hardware to perform operations comprising: reserving a resource unit of a multiplexed data transmission for time-sensitive data; transmitting a preamble followed by one or more padding frames on the reserved resource unit; continuing to transmit padding frames on the reserved resource unit until an arrival of time sensitive data; and transmitting a data field containing the time sensitive data on the reserved resource unit.

A method for reducing latency of a data transmission is described and includes: reserving a resource unit of a multiplexed data transmission for time-sensitive data; transmitting a preamble followed by one or more padding frames (e.g. empty AMPDU subframes) on the reserved resource unit; continuing to transmit padding frames on the reserved resource unit until an arrival of time sensitive data; and transmitting a data field containing the time sensitive data on the reserved resource unit.

Other aspects and advantages of the described embodiments will become apparent from the following detailed description taken in conjunction with the accompanying drawings which illustrate, by way of example, the principles of the described embodiments.

### BRIEF DESCRIPTION OF THE DRAWINGS

Example embodiments will be described and explained with additional specificity and detail through the use of the accompanying drawings in which:

FIG. 1 shows an example timeline of events for a scenario where contention is not started until shortly after the arrival of the data;

FIG. 2 illustrates a timeline of events for a scenario where contention is not able to start until after a prior transmission has ended;

FIG. 3 shows the case where contention is started ahead of the arrival of the data and the data arrives shortly before the start of the frame's data field;

FIG. 4 shows how the start of the PPDU's data field might not align with the arrival of time sensitive data;

FIG. 5 shows the structure of an exemplary A-MPDU;

FIG. 6 shows an A-MPDU with end-of-frame padding;

FIG. 7 shows an example of intra-frame padding;

FIG. 8 shows how all padding can be inserted at the start of an A-MPDU, before a first of data-carrying A-MPDU subframes;

FIGS. 9A-9C show how start-of-frame padding can be used to accommodate the case where the data field starts before time-sensitive data actually arrives;

FIG. 10 shows an exemplary multiplexed transmission, in accordance with the described embodiments;

FIG. 11 illustrates the benefits on data transmission latency using the low latency processing techniques described in the text accompanying FIGS. 5-9C;

FIGS. 12A-12B illustrate the benefits on data transmission latency using the low latency processing techniques described in the text accompanying FIG. 10;

FIG. 13 shows a flow chart illustrating a method for reducing latency of a data transmission; and

FIG. 14 shows a schematic view illustrating a machine in the example form of a computing device within which a set of instructions, for causing the machine to perform any one or more of the methods discussed herein, may be executed.

### DETAILED DESCRIPTION

For time-sensitive data, it may be desirable to have a packet on a transmission medium as soon as possible after the data arrives in a transmit buffer. However, there are inherent delays when sending data over Wi-Fi. Typically, the start of contention (and subsequent access to the medium) is triggered by the availability of data. This means that, even if the data gets high priority, inevitably some time is spent contending for the medium, sending the preamble, etc. even when the medium is not occupied by transmission from one or more other devices trying to use the same wireless network.

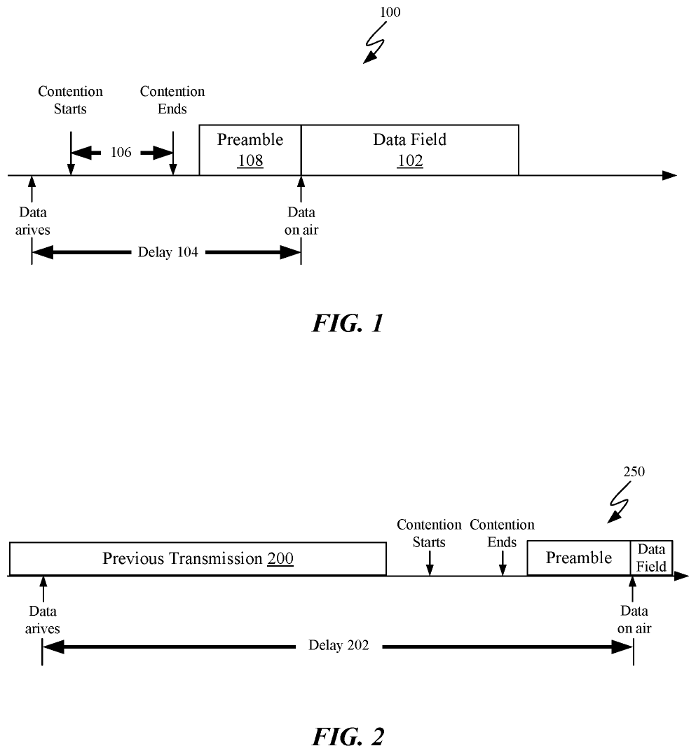

FIG. 1 shows an example timeline of events for a scenario where contention is not started until shortly after the arrival of the data. In such a scenario, it takes until the start of a data field 102 of a data transmission 100 to consider the data as being transmitted over the air. Consequently, the result of waiting until the data arrives is a delay 104 that is driven by at least a contention delay 106 and the time needed for transmission of preamble 108 of transmission 100. Contention delay 106 can vary substantially in length depending on how many devices are competing to use a particular Wi-Fi network but generally takes between 100 and 300 microseconds. Preamble 108 is generally about 50 microseconds but could also vary between 25 and 75 microseconds depending on a preamble implementation being used. It should be noted that data field 102 can include one or more data-carrying subframes configured to contain any data to be incorporated into data transmission 100.

When the medium is occupied, the delay is higher since any pending transmission (in this case, the time-sensitive data) needs to additionally wait for the medium to become available.

FIG. 2 illustrates a timeline of events for a scenario where contention is not able to start until after a prior transmission 200 has ended. The additional time added by having to wait until prior transmission 200 ends results in a delay 202, which is much longer than delay 104 previously described in the text accompanying FIG. 1. This can be problematic in situations where the transmission latency for transmission 250 caused by previous transmission 200 falls below a performance threshold.

Given that typically, the start of contention is triggered by the availability of data, these delays may seem unavoidable. However, this need not be the case in many scenarios, and, for example, when the data follows a predictable pattern, as some time-sensitive traffic will.

### Example 1: Reduced Delay for Predictable Time-Sensitive Data

When the arrival of time-sensitive data (and the amount of data) can be predicted with reasonable precision, contention and transmission of the preamble may start before the data is available in the transmit buffer. When the access to the medium is timed correctly, the frame's payload can then be constructed “just in time” when the data arrives at the expected time instance. This may eliminate any delay between the arrival of the data and the time the data is being transmitted over the medium. For example, certain time-sensitive data can be received at a known interval. This interval could be at fixed absolute times. Alternatively, successive arrivals of time-sensitive data can be separated by a consistent interval of time once started. In these embodiments, an electronic device responsible for sending the aforementioned transmissions can be configured to determine with accuracy an expected arrival time for the time-sensitive data transmission. In some embodiments, the arriving data can contain scheduling information informing the electronic device of times at which subsequent time-sensitive data will be arriving.

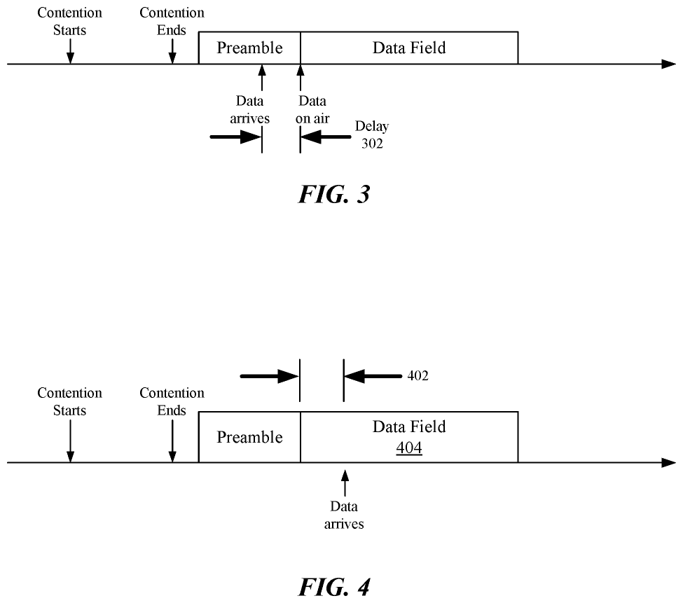

FIG. 3 shows the case where contention is started ahead of the arrival of the data and the data arrives shortly before the start of the frame's data field. In this case, the delay between arrival of the data and the time that the data is actually on the air is reduced significantly relative to e.g., FIG. 1. However, contention duration is sometimes unpredictable, driven by random numbers and dependent on activity of other devices on the medium. As such, the exact moment a physical layer protocol data unit (PPDU) starts may not be predicted with extremely precise certainty.

Consequently, FIG. 4 shows how the start of the PPDU's data field might not align with the arrival of time-sensitive data. If the data arrives before the start of the PPDU's data field (as in e.g., FIG. 3), this is not an issue. However, if the data arrives after the start of the PPDU's data field, some extra functionality is needed, since otherwise the arriving data might not be transmitted until another data transmission is initiated.

Since there can be no gap between the end of the preamble and the start of the data field, the time in which the data is not yet available may be bridged. This could be achieved with some form of padding. The next section contains a proposal for this. First, a briefly summary of the types of padding that are already defined in 802.11 and how they may differ from the padding that would be used in this disclosure. The payload of the 802.11 frame may include an aggregate MAC Protocol Data Unit (MPDU) (A-MPDU), which concatenates a variable number of individual MPDUs.

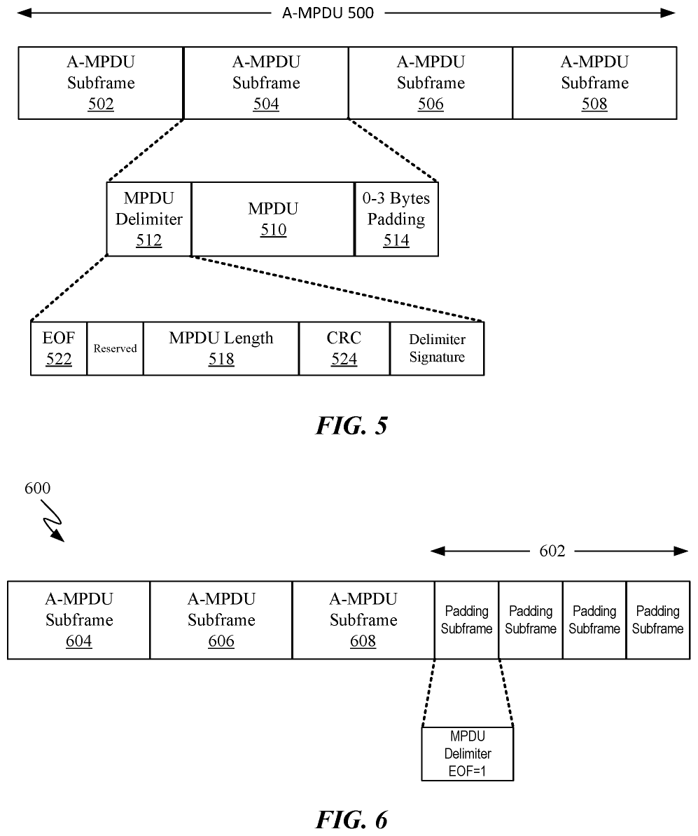

FIG. 5 shows the structure of an exemplary A-MPDU. The A-MPDU may include a succession of “subframes” 502-508. Each subframe may include an MPDU 510 containing data to be transmitted preceded with a four-byte MPDU delimiter 512 and possibly appended with up to 3 bytes padding 514 (to make each subframe a multiple of 4 bytes). MPDU delimiter 512 contains an MPDU length 518, a cyclic redundancy check (CRC) 520 and an end of frame (EOF) bit 522 that can be used to indicate whether additional subframes are expected to follow.

MPDU delimiter 512 is also used to provide various forms of padding in A-MPDU 500. Specifically, MPDU delimiter 512 is used to provide end-of-frame padding and minimum MPDU start spacing padding.

### End-of-Frame Padding

When the expected duration of the PPDU is longer than what is needed to transmit the A-MPDU, extra (dummy) payload is created by adding padding that includes delimiters (subframes with zero MPDU length). These padding subframes can be filtered out by the MAC at the receiving side. Padding subframes can also be referred to as empty or null subframes as they are not considered data-carrying subframes.

FIG. 6 shows an A-MPDU 600 with end-of-frame padding 602. Since all padding 602 occurs at the end of MPDU 600 (after the last data-carrying A-MPDU subframes 604-608), the EOF field of the delimiters used for end-of-frame padding subframes making up padding 602 is set to 1, as depicted. This can help the MAC decide that no further data is expected from the PHY, which can eliminate unnecessary processing.

Minimum MPDU start spacing. Some receiver implementations have limitations in the number of MPDUs they can process and require some delay between two successive MPDUs. To achieve this, a time gap is created between the end of one subframe and the beginning of the next by the insertion of subframe delimiters. The amount of padding is chosen as a function of the data rate to create the desired time gap. The gap is intended to alleviate the processing burden at the receiver.

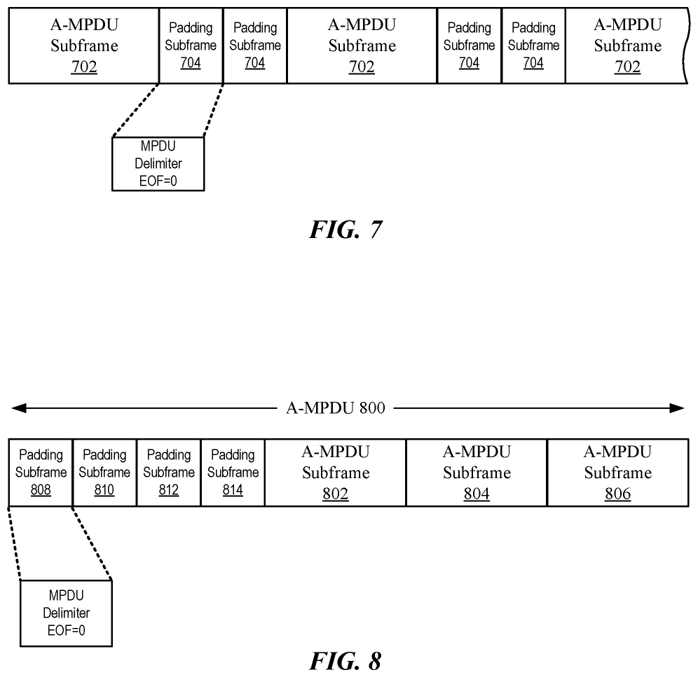

FIG. 7 shows an example of intra-frame padding, where padding subframes 704 are inserted between data-carrying A-MPDU subframes 702 of a data field of a data transmission. In this case, the EOF subfield in the padding delimiters is set to 0, as depicted, since data-carrying A-MPDU subframes 702 can resume after insertion of the padding delimiters in padding subframes 704.

### Start-of-Frame Padding

Taking the EOF padding and Minimum MPDU start spacing padding as the examples, the issue shown in FIG. 4 can be addressed with a new, but similar type of padding.

FIG. 8 shows how all padding can be inserted at the start of an A-MPDU 800, before a first of data-carrying A-MPDU subframes 802-806. The padding delimiters' EOF bit for padding subframes 808-814 may be set to 0, as depicted, since more data-carrying subframes are expected.

The MAC already supports ignoring padding subframes and parsing of the A-MPDU byte stream for data-carrying subframes 808-814. We could reuse these capabilities to define start-of-frame padding.

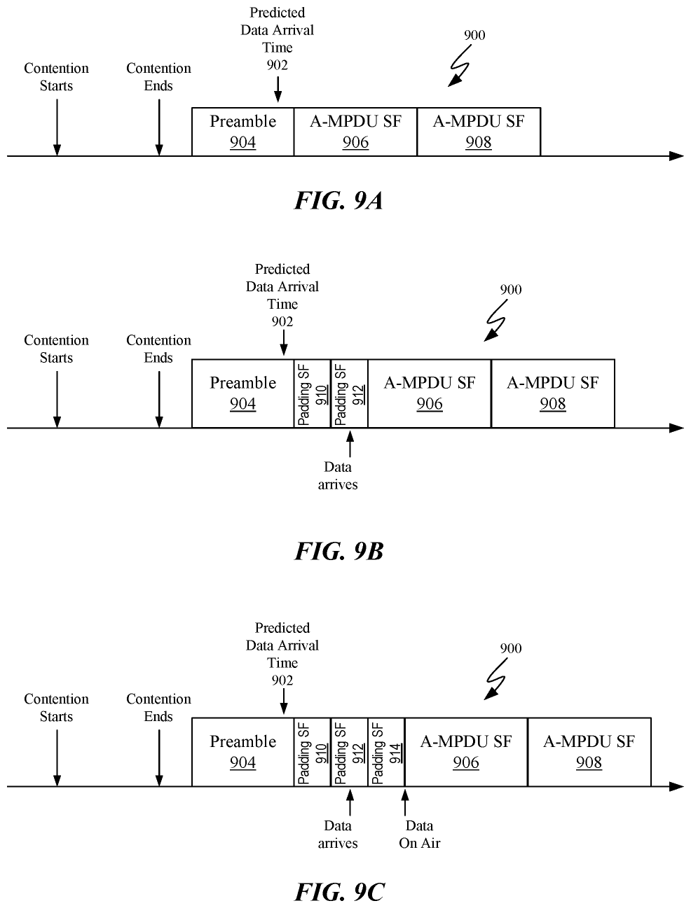

FIGS. 9A-9C show how this start-of-frame padding can be used to accommodate the case where the data field starts before time-sensitive data actually arrives. FIG. 9A shows how a data transmission 900 can be initiated so that a predicted arrival time of the time-sensitive data occurs near the end of preamble 904. This allows a time period between arrival of the time-sensitive data and the beginning of A-MPDU subframe 906 to be minimized, thereby minimizing latency of the time-sensitive data transmission.

FIG. 9B shows how in some embodiments an actual arrival of the data does not coincide exactly with its predicted arrival time. Prediction inaccuracies can have many causes including signal jitter, which on its own can result in timing variations that can result in the need for the addition of a padding frame. In the event the arrival time is later than the predicted arrival time, padding subframes 910-912 can be added between preamble 904 and A-MPDU subframe 906 to avoid a situation in which A-MPDU subframe 906 starts before the arrival of the time-sensitive data, which in this particular example happens half-way through padding subframe 912.

FIG. 9C shows how an additional padding subframe 914 is added in the event that half the length of padding subframe 912 is insufficient to process the received time-sensitive data for incorporation into A-MPDU subframe 906. In this way, the received data can be incorporated into A-MPDU subframe 906 and in some embodiments, where needed to contain all of the time-sensitive data received, into A-MPDU subframe 908.

In some embodiments, the time-sensitive data arrives at the buffer of an exemplary electronic device. However, in other embodiments a device can be configured to operate in accordance with the described embodiments without permanently or temporarily storing the received time-sensitive data in local storage, such as a buffer prior to processing the time-sensitive data and sending it out in a data field, such as A-MPDU subframe 906. In this way, the issues with late arrival of time-sensitive data discussed in relation to FIG. 4 can be addressed. It should be noted that while the use of the standards associated with A-MPDU subframes has been used to describe one method of implementation, this example is given for exemplary purposes only and should not be construed to imply a loss of generality of the described embodiments. In particular, the described embodiments can be used with different forms of padding and work with various other data field types.

In some embodiments, a combination of end-of-frame padding, intra-frame padding and/or start-of-frame padding can be used. For example, the use of a combination of padding types can help when time-sensitive data is received in quick succession. In such a case, start-of-frame padding can be used to align a first data field of a data transmission with the arrival of a first set of time-sensitive data and the addition of intra-frame padding can help align the arrival of one or more sets of additional time-sensitive data with additional data fields of the data transmission.

For time-sensitive traffic with predictable arrival times (and predictable size), initiating a data transmission prior to the arrival of time-sensitive data allows for an early contention process, which reduces the delay between the arrival of data and transmission of data on the air. Start-of-frame padding can be used when the arrival of the data and the start of the data field are not properly aligned.

This example addresses the case where the medium is available at (or around) the time when the data arrives. To accommodate time-sensitive data (with or without a predictable arrival time), a somewhat different approach may be used. This is discussed in the next section.

### Example 2: Reduced Delay for Unpredictable Time-Sensitive Data

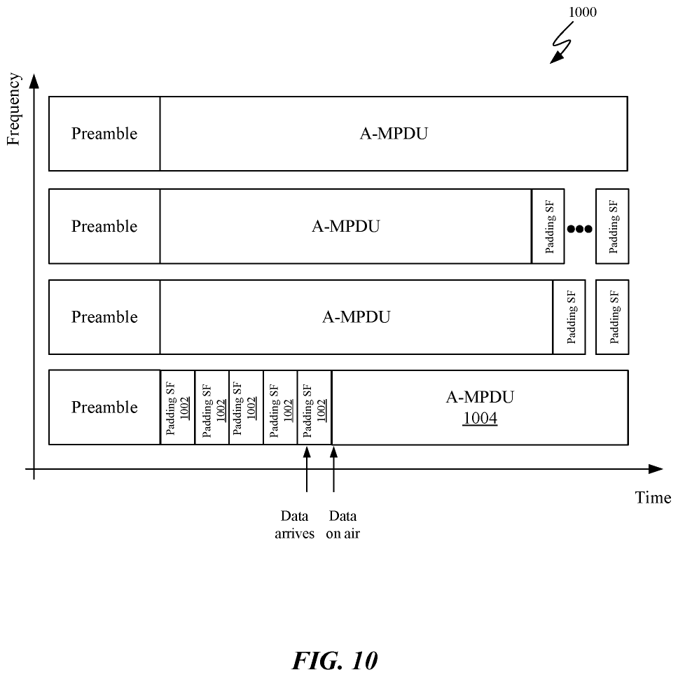

FIG. 10 shows an exemplary multiplexed transmission 1000 useful in scenarios where a time-sensitive packet is delayed by an ongoing transmission (as in e.g., FIG. 2). FIG. 10 shows how the time sensitive data can be sent out using OFDMA, however other forms of multiplexing such as time division multiplexing or code division multiplexing could be used to allow concurrent use of available bandwidth by multiple devices/users.

The exemplary OFDMA transmission can be configured for multiple users, or configured for a single user using a multiple resource unit (MRU). Inside this exemplary OFDMA transmission 1000, one resource unit (RU) may be reserved for the time-sensitive traffic. If no such traffic is available, the payload of this RU may be made up of solely start-of-frame padding. However, when time-sensitive traffic appears at one of padding subframes 1002 as depicted, the data can immediately be incorporated into A-MPDU 1004 associated with the reserved RU without delay or without having to wait for the end of the PPDU.

In FIG. 10, the lowest of the depicted four RUs is initially not carrying any data, only start-of-frame padding in the form of padding subframes 1002. When actual data arrives, it can immediately be transmitted as part of the ongoing PPDU, rather than having to wait for the next transmission. In some embodiments, the lowest of the depicted four RUs can be allocated about 20 MHz of bandwidth for transmission of time-sensitive data.

In some embodiments, both the ongoing transmission and the time-sensitive data originate at the same transmitter.

Disclosed are multiple ways in which time-sensitive traffic can avoid the delays that typically occur within the Wi-Fi protocol. One approach is to initiate contention early when the traffic has a predictable pattern and arrival times. This is mostly useful when the medium is not occupied at the moment the time-sensitive traffic arrives because the amount of time contention takes can be predicted with greater accuracy. In embodiments leveraging A-MPDUs, a new form of A-MPDU padding, namely start-of-frame padding is used.

Additionally, one or more RUs in an OFDMA transmission could be reserved for time-sensitive traffic even if such traffic is not yet available at the start of the OFDMA frame. Generally larger numbers of RUs, representing a larger portion of available bandwidth, can be utilized when higher volumes of time-sensitive data are anticipated. Using start-of-frame padding could also be used here to create dummy payload (i.e. padding subframes) until any time-sensitive traffic becomes available. When time-sensitive traffic arrives, it can then be transmitted in the reserved RU.

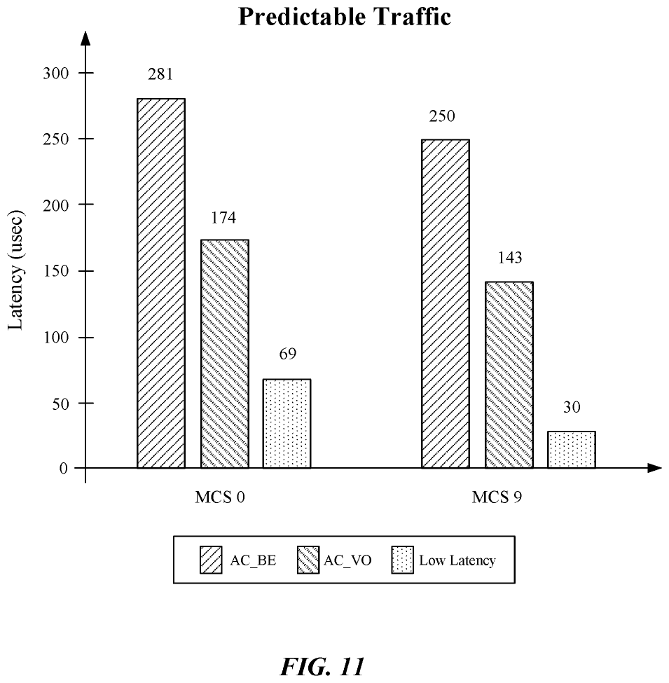

FIG. 11 illustrates the benefits of the described embodiments on data transmission latency (the delay between arrival of data and its transmission. In particular, FIG. 11 depicts the average latency using the low latency processing techniques described in the text accompanying FIGS. 5-9C and compares these latencies with latencies achieved for high priority data transmissions (AC_VO) and lower priority data transmissions (AC_BE) that do not benefit from the described embodiments. As depicted, use of the low latency techniques are nearly three times shorter than high priority data transmissions (AC_VO) using MCS 0 modulation (a form of BPSK modulation) and over four times shorter than high priority data transmissions (AC_VO) using MCS 9 modulation (a form of 256QAM modulation).

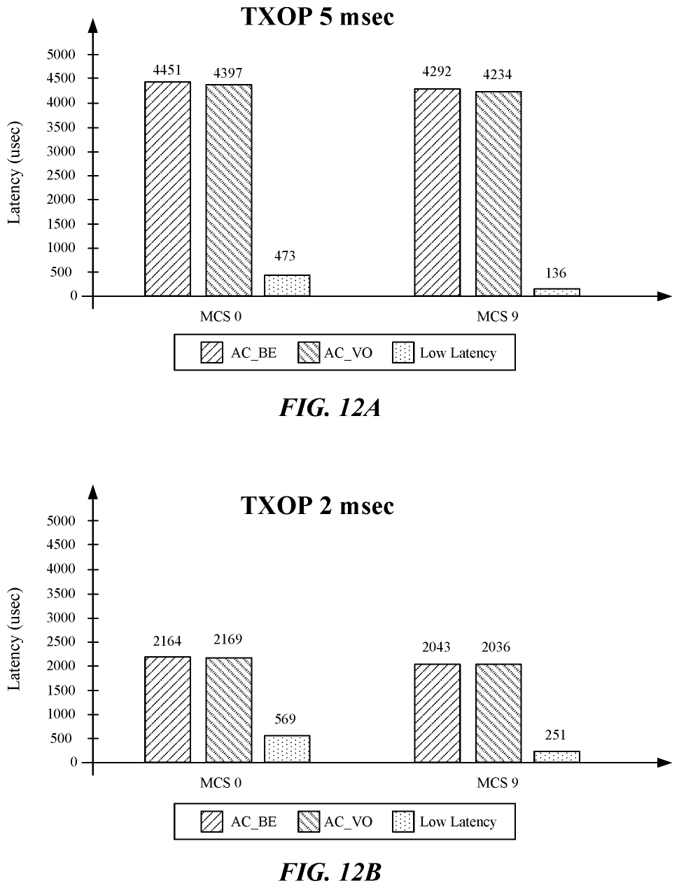

FIGS. 12A-12B illustrate the benefits of the described embodiments on data transmission latency using the low latency processing techniques described in the text accompanying FIG. 10 and suitable for use with time-sensitive traffic arriving at unpredictable times. FIG. 12A shows relative performance with Wi-Fi stations authorized to transmit data for a period of five microseconds. FIG. 12A shows how latency using the low latency techniques associated with unpredictable arrival times is nearly an order of magnitude shorter than AC_BE and AC_VO priority transmissions. FIG. 12B shows relative performance with Wifi stations authorized to transmit data for a period of two microseconds. The latency differential shown in FIG. 12B can be less severe as delays experienced by AC_BE and AC_VO priority transmissions experience less delay to start as traffic received during another transmission on average incurs less of a penalty due to the shorter data transmission periods.

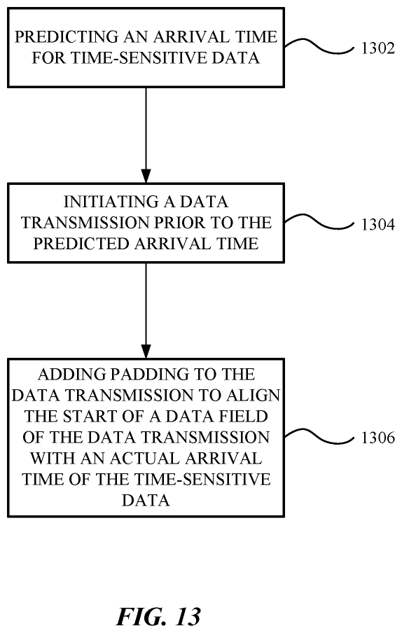

FIG. 13 shows a flow chart illustrating a method for reducing latency of a data transmission. At 1302, an arrival time for time-sensitive data is predicted. The prediction for the arrival time can be determined in numerous ways. For example, the prediction can be based on regular release intervals or a regular schedule of releases of the time-sensitive data. At 1304, a data transmission is initiated prior to the predicted arrival time for the time sensitive data. In some embodiments, the transmission of the data transmission can be timed so that a data field of the data transmission begins shortly after the predicted arrival time for the time-sensitive data. In some embodiments, the timing of the transmission of the data transmission can be based on an amount of traffic being experienced on the data network and how the traffic is predicted to affect a contention delay experienced when initiating the data transmission. At 1304, padding is added to the data transmission to align a start of the data field of the data transmission with an actual arrival of the time-sensitive data.

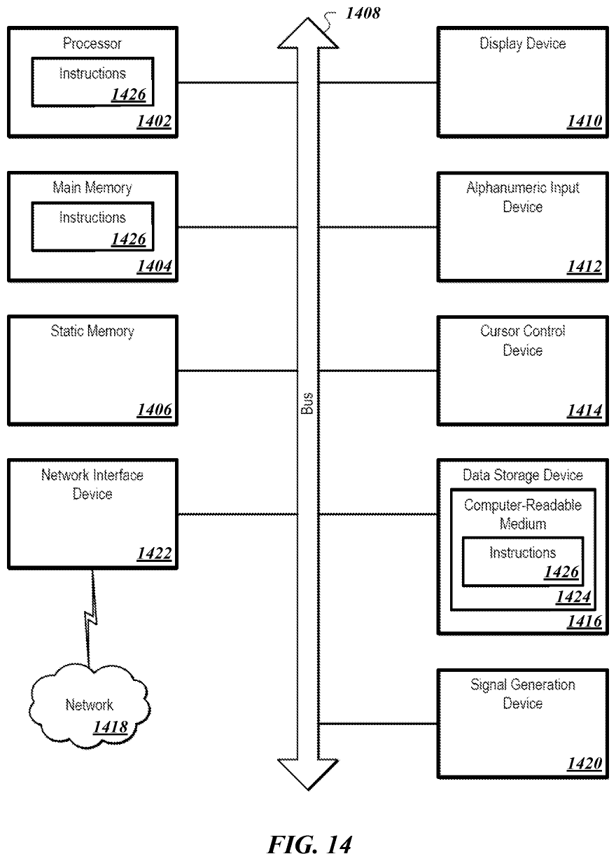

FIG. 14 shows an example computing device 1400 includes a processing device (e.g., a processor) 1402, a main memory 1404 (e.g., read-only memory (ROM), flash memory, dynamic random access memory (DRAM) such as synchronous DRAM (SDRAM)), a static memory 1406 (e.g., flash memory, static random access memory (SRAM)) and a data storage device 1416, which communicate with each other via a bus 1408.

Processing device 1402 represents one or more general-purpose processing devices such as a microprocessor, central processing unit, or the like. More particularly, the processing device 1402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1402 may also include one or more special-purpose processing devices such as an application specific integrated circuit (ASIC), a field programmable gate array (FPGA), a digital signal processor (DSP), network processor, or the like. The processing device 1402 is configured to execute instructions 1426 for performing the operations and steps discussed herein.

The computing device 1400 may further include a network interface device 1422 which may communicate with a network 1418. The computing device 1400 also may include a display device 1410 (e.g., a liquid crystal display (LCD) or a cathode ray tube (CRT)), an alphanumeric input device 1412 (e.g., a keyboard), a cursor control device 1414 (e.g., a mouse) and a signal generation device 1420 (e.g., a speaker). In at least one implementation, the display device 1410, the alphanumeric input device 1412, and the cursor control device 1414 may be combined into a single component or device (e.g., an LCD touch screen).

The data storage device 1416 may include a computer-readable storage medium 1424 on which is stored one or more sets of instructions 1426 embodying any one or more of the methods or functions described herein. The instructions 1426 may also reside, completely or at least partially, within the main memory 1404 and/or within the processing device 1402 during execution thereof by the computing device 1400, the main memory 1404 and the processing device 1402 also constituting computer-readable media. The instructions may further be transmitted or received over a network 1418 via the network interface device 1422.

While the computer-readable storage medium 1426 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In an example, a multi-link device may include a memory and one or more processors operatively coupled to the memory. The one or more processors may be configured to execute operations including to obtain data to be transmitted, the data including latency sensitive data and non-latency sensitive data, assign at least a portion of the latency sensitive data to a first channel, and assign non-latency sensitive data to a second channel, the first channel having a smaller width than the second channel. The example multi-link device may include a first link and a second link, where the first channel is associated with the first link of the multi-link device, where the second channel is associated with the second link of the multi-link device. The example multi-link device may be configured to operate in a 320 MHz or greater system. The example multi-link device may include first channel being assigned based on an interference measurement related to the first channel.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A system for wireless communication, the system comprising:
data processing hardware; and
memory hardware in communication with the data processing hardware, the memory hardware storing instructions that when executed on the data processing hardware cause the data processing hardware to perform operations comprising:
predicting an arrival time for time-sensitive data;
initiating a data transmission prior to the predicted arrival time for the time-sensitive data; and
when an actual arrival time of the time-sensitive data and a beginning of a data field of the data transmission are not aligned, adding padding to the data transmission to align the beginning of the data field with the actual arrival time of the time-sensitive data.

2. The system of claim 1, wherein adding padding to the data transmission comprises inserting one or more padding subframes between a preamble of the data transmission and one or more subframes of the data field containing the time-sensitive data.

3. The system of claim 1, wherein adding padding to the data transmission comprises inserting padding sub-frames between a preamble of the data transmission and one or more subframes configured to contain the time-sensitive data until the time-sensitive data arrives.

4. The system of claim 1, wherein the data transmission is initiated at a time determined to position the beginning of the data field a predetermined period of time after the predicted arrival time for the time-sensitive data.

5. The system of claim 1, wherein the arrival time for the time-sensitive data is predicted using a known time interval between arrivals of successive sets of time sensitive data.

6. The system of claim 1, wherein the data transmission is performed using a Wi-Fi protocol.

7. A method for reducing latency of a data transmission, the method comprising:
predicting an arrival time for time-sensitive data;
initiating a data transmission prior to the predicted arrival time for the time-sensitive data; and
when an actual arrival time of the time-sensitive data and a beginning of a data field of the data transmission are not aligned, adding padding to the data transmission to align the beginning of the data field with the actual arrival time of the time-sensitive data.

8. The method of claim 7, wherein adding padding to the data transmission comprises inserting one or more padding subframes between a preamble of the data transmission and the subframes containing the data transmission.

9. The method of claim 7, wherein adding padding to the data transmission comprises inserting padding sub-frames between a preamble of the data transmission and one or more subframes of the data field configured to contain the time-sensitive data until the time-sensitive data arrives.

10. The method of claim 7, wherein the data transmission is initiated at a time determined to position the beginning of the data field a predetermined period of time after the predicted arrival time for the time-sensitive data.

11. The method of claim 7, wherein the arrival time for the time-sensitive data is predicted using a known time interval between arrivals of successive sets of time sensitive data.

12. The method of claim 7, wherein the data transmission is performed using a Wi-Fi protocol.

13. A system for wireless communication, the system comprising:
data processing hardware; and
memory hardware in communication with the data processing hardware, the memory hardware storing instructions that when executed on the data processing hardware cause the data processing hardware to perform operations comprising:
reserving a resource unit of a multiplexed data transmission for time-sensitive data;
transmitting a preamble followed by one or more empty frames using the reserved resource unit;
continuing to transmit empty frames on the reserved resource unit until an arrival of the time sensitive data; and
transmitting a data field containing the time sensitive data on the reserved resource unit.

14. The system of claim 13, wherein reserving the resource unit of the multiplexed data transmission comprises reserving a plurality of resource units of the multiplexed data transmission.

15. The system of claim 14, wherein transmitting the preamble followed by one or more empty frames on the reserved resource unit comprises transmitting a preamble followed by one or more empty frames on each of the plurality of reserved resource units.

16. The system of claim 13, wherein the data transmission is performed using a Wi-Fi protocol.

17. The system of claim 13, wherein the multiplexed data transmission is an OFDMA data transmission.

18. The system of claim 13, wherein the reserved resource unit is allocated 20 MHz of bandwidth.

19. A method for reducing latency of a data transmission, the method comprising:
reserving a resource unit of a multiplexed data transmission for time-sensitive data;
transmitting a preamble followed by one or more empty frames using the reserved resource unit;
continuing to transmit empty frames on the reserved resource unit until an arrival of the time sensitive data; and
transmitting a data field containing the time sensitive data on the reserved resource unit.

20. The method of claim 19, wherein reserving the resource unit of the multiplexed data transmission comprises reserving a plurality of resource units of the multiplexed data transmission.

21. The system of claim 20, wherein transmitting the preamble followed by one or more empty frames on the reserved resource unit comprises transmitting a preamble followed by one or more empty frames on each of the plurality of reserved resource units.

22. The system of claim 19, wherein the data transmission is performed using a Wi-Fi protocol.

23. The system of claim 19, wherein the multiplexed data transmission is an OFDMA data transmission.

24. The system of claim 1, wherein the reserved resource unit is allocated 20 MHz of bandwidth.
